(19) United States
(12) Patent Application Publication
(10) Pub. No.: US 2004/0010460 A1
(43) Pub. Date: Jan. 15, 2004

(54) Method for providing two-tier commercial contract pricing

(76) Inventor: Stephen L. Taylor, Rancho Santa Fe, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/192,267

(22) Filed: Jul. 10, 2002

(51) Int. Cl. G06F 17/60

(52) U.S. Cl. 705/37

(57) ABSTRACT

A method of providing two-tier commercial contract pricing includes providing a contracting party with at least one commercial contract having an option of an arbitration provision or not having an arbitration provision, the at least one commercial contract including at least two price levels, a first price level if the arbitration provision is selected, and a second price level if the arbitration provision is not selected; allowing the contracting party to select the first price level with the arbitration provision or the second price level without the arbitration provision; and executing the at least one commercial contract with or without the arbitration provision and at the corresponding price level as selected by the contracting party.

### FIELD OF THE INVENTION

The present invention is, in general, in the field of two-tier commercial contract pricing, and, in particular, in the field of two-tier commercial contract pricing for contracts with and without an arbitration provision.

### BACKGROUND OF THE INVENTION

An increasing number of lawsuits have been filed against senior care living centers by family members when loved ones die under the care of the senior living center. Family members will often blame a senior living center for the death of a loved one and bring suit against the center for financial restitution or gain.

In an effort to avoid litigation and the associated costs, which increase the cost of senior care for all residents, senior living centers often require a contracting party/resident to agree to an arbitration provision in a senior living care contract between the senior living center and the contracting party/resident. The arbitration provision provides that in the event of a dispute arising from or related to the contract or to residency or care at the senior living center, the contracting parties agree to have the dispute resolved by arbitration (as opposed to having the dispute resolved by a court of law before a jury).

Despite an agreement on the use of arbitration in the event of a dispute, these arbitration provisions are often determined by courts to be “unconscionable” and, thus, unenforceable. Courts often determine these arbitration provisions are “unconscionable” because the contracting party/resident requires the care of the senior living center, and, hence, has to sign the care contract without a real choice on arbitration. If the arbitration provision is found to be unenforceable, the plaintiff is likely to bring a legal suit before a jury in an effort to obtain a large, emotionally base jury verdict for the plaintiff. The increasing cost of litigation to the senior living centers is reflected in the increasing rates charged by the senior living centers to all residents. This litigation also is an additional burden on an already overburdened judicial system.

### SUMMARY OF THE INVENTION

Accordingly, an aspect of the invention involves a two-tier pricing method for commercial contracts such as, but not limited to, senior living care contracts, where the care contract may provide for 1) a reduced fee if an arbitration provision is agreed to by the contracting party/resident, and 2) a higher fee if an arbitration provision is not agreed to. With a two-tier pricing system, where the contracting party/resident has an actual choice on arbitration, courts are more likely to enforce an agreed-up arbitration provision because the arbitration provision is less likely to be considered unconscionable.

Another aspect of the invention involves a method of providing two-tier commercial contract pricing. The method includes the steps of providing a contracting party with at least one commercial contract; providing the contracting party with an option with the at least one commercial contract of having an arbitration provision or not having an arbitration provision, the at least one commercial contract including at least two price levels, a first price level if the arbitration provision is selected, and a second price level if the arbitration provision is not selected; allowing the contracting party to select the first price level with the arbitration provision or the second price level without the arbitration provision; and executing the at least one commercial contract with or without the arbitration provision and at the corresponding price level as selected by the contracting party.

A further aspect of the invention involves a method of providing two-tier senior care pricing. The method includes the steps of providing a senior care contracting party with a senior care contract, the senior care contract including at least an option for an arbitration provision in the senior care contract and corresponding first price level and an option to not include an arbitration provision in the senior care contract and corresponding second price level different than the first price level; allowing the senior care contracting party to select the option for an arbitration provision in the senior care contract and corresponding first price level or the option to not include an arbitration provision in the senior care contract and corresponding second price level; and executing the senior care contract with the arbitration provision in the senior care contract and corresponding first price level or without the arbitration provision in the senior care contract and corresponding second price level.

A still further aspect of the invention involves a method of providing two-tier senior care pricing. The method includes the steps of providing a senior care contracting party with at least two senior care contracts, a first senior care contract including an arbitration provision and a corresponding first price level and a second senior care contract without an arbitration provision and a corresponding second price level different than the first price level; allowing the senior care contracting party to select at least the first senior care contract with an arbitration provision at the first price level or the second senior care contract without an arbitration provision at the second price level; and executing either the first senior care contract with an arbitration provision at the first price level or the second senior care contract without an arbitration provision at the second price level.

Further objects and advantages will be apparent to those skilled in the art after a review of the drawings and the detailed description of the preferred embodiments set forth below.

### BRIEF DESCRIPTION OF THE DRAWINGS

FIG. 1 is a flowchart illustrating an exemplary two-tier pricing method for a commercial contract where pricing depends at least in part on whether an arbitration provision is selected.

### DETAILED DESCRIPTION OF PREFERRED EMBODIMENTS

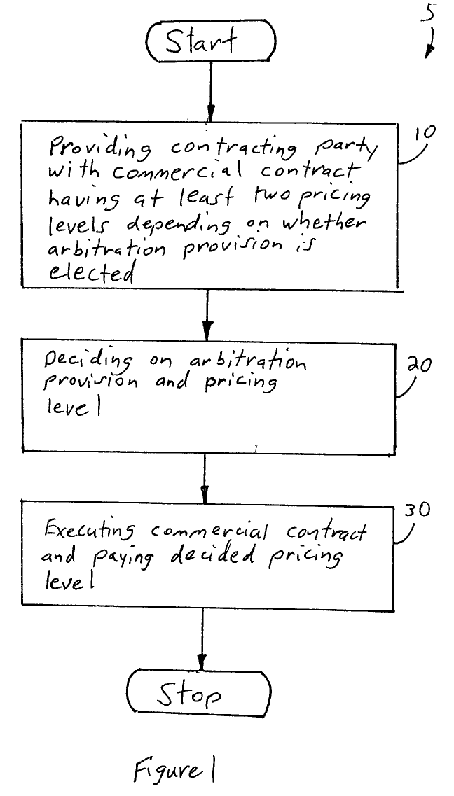

With reference to FIG. 1, an exemplary two-tier pricing method 5 for a commercial contract where pricing depends at least in part on whether an arbitration provision is selected will now be described. Although the two-tier pricing method 5 will be described in conjunction with a senior care contract, the two-tier pricing method 5 may be used in conjunction with any type of commercial contract. Further, although the method 5 described below is described as a two-tier pricing method, the method 5 includes similar methods where pricing depends at least in part on whether an arbitration provision is selected and the number of pricing tiers or levels is greater than one (e.g., three-tier pricing method, four-tier pricing method, etc.).

In a first step 10, the two-tier pricing method 5 includes providing another contracting party with a commercial contract having at least two pricing levels depending on whether an arbitration provision is elected. In the exemplary two-tier pricing method 5 for a senior living center, the commercial contract is a senior care contract between at least the following contracting parties: 1) the senior living center or senior care provider, and 2) the potential resident. The senior care contract includes numerous provisions describing the rights and responsibilities of both the senior living center and the resident. The senior care contract includes at least two pricing levels that correspond at least partially on whether the resident selects an arbitration provision in the event of a dispute. For example, the senior care contract may provide for a first price (e.g., $5,000 per month) for senior care services if an arbitration provision is agreed to in the event of any dispute, and a second price (e.g., $5,500 per month) for senior care services if an arbitration provision is not agreed to in the event of any dispute (i.e., resident and/or family may pursue resolution of the dispute through a legal court proceeding).

The following is an exemplary arbitration provision in the senior care contract that may be elected by a resident choosing the first price (e.g., $5,000 per month) for senior care services:

Arbitration:

By entering into this Agreement, you agree that any and all claims or disputes arising from or related to the Agreement or to your residency or care at (Senior Living Center) shall be resolved by submission to neutral, binding arbitration (including, but not limited to, claims of personal injury and property damage). Accordingly, both parties give up their constitutional right to have any such dispute decided in a court of law before a jury, and instead accept the use of arbitration.

The arbitration shall be conducted by one or more neutral arbitrators selected from the (Arbitration Association) in (City), unless otherwise mutually agreed. In reaching a decision, the arbitrator(s) shall prepare findings of fact and conclusions of law. Each party shall bear its own costs and fees for the arbitration.

This arbitration clause binds all parties whose claims or disputes may arise or relate to the Agreement or to your residency or care at (Senior Living Center), including any spouse or heirs, representatives, executors, administrators, successors, and assigns of such parties. After the effective date of termination of the Agreement, this arbitration clause shall remain in effect for the resolution of all claims or disputes unresolved as of that date.

It is important for the senior care contract provided in step 10 to clearly give the resident a real choice on arbitration. To clearly give the resident a real choice on arbitration, the difference in price between the pricing levels should be reasonable and generally reflect the difference in cost to the senior living center for the two types of contracts. This difference in cost may be calculated by an actuary and may be the difference in cost to the senior living care center between resolving an average dispute by arbitration and resolving an average dispute by litigation multiplied by the probability that a dispute with occur.

The care contract may also prominently indicate to the resident that the arbitration provision is an option and is not required for doing business with the senior living care center. The contract may also prominently show the difference in price for the two contract options. The contract may also allow for the resident to clearly indicate by check mark, initials, etc. whether they are selecting and paying for the senior care contract (1) with arbitration provision, or (2) without arbitration provision so that it is clear that the resident has a choice on arbitration.

Instead of providing the resident/contracting party with the options of (1) an arbitration provision, or (2) no arbitration provision in a single senior care contract, these options may be provided in two or more senior care contracts. For example, a first senior care contract may have an arbitration provision and a corresponding first price level and a separate second senior care contract may not have an arbitration provision and a corresponding second price level greater than the first price level. If the resident/contracting party wants an arbitration provision in the contract at the lower price, the first senior care contract is used and if the resident/contracting party does not want an arbitration provision in the contract at the higher price, the second senior care contract is used. The first senior care contract may include language indicating in effect that the senior care contracting party has the option of a senior care contract without an arbitration provision at a second price level, and the second senior care contract may include language indicating in effect that the senior care contracting party has the option of a senior care contract with an arbitration provision at a first price level.

In step 20, the resident decides on whether to include an arbitration provision in the contract and the corresponding price level. As indicated above, the resident may indicate a check mark, initials, etc. to indicate selection of (1) a care contract with an arbitration provision and the corresponding price level, or (2) a care contract without an arbitration provision and the corresponding price level.

In step 30, the care contract may be executed by the resident by signing and dating the care contract. Instead of, or in addition to, a resident's signature, the care contract may be signed and dated by a family member, guardian, guarantor, or the like. A representative of the senior living center may also sign and date the care contract. The care contract may also be witnessed.

The two-tier pricing method 5 of the present invention gives a contracting party/resident a real choice on arbitration. Providing the resident with a real choice on an arbitration provision reduces the likelihood that an arbitration provision will be found unconscionable, and, thus, unenforceable. This reduces the expense of senior care for the resident selecting the arbitration provision because the resident pays a lower rate than if an arbitration provision is not selected. Further, the two-tier pricing method 5 reduces the expense of senior care for all residents because the number of costly and time-consuming lawsuits faced by the senior living center is reduced, promotes relatively inexpensive and speedy arbitration of disputes, and reduces the number of such disputes handled by the judicial system.

It will be readily apparent to those skilled in the art that still further changes and modifications in the actual concepts described herein can readily be made without departing from the spirit and scope of the invention as defined by the following claims.

What is claimed is:

1. A method of providing two-tier commercial contract pricing, comprising the steps of:
providing a contracting party with at least one commercial contract;
providing the contracting party with an option with the at least one commercial contract of having an arbitration provision or not having an arbitration provision, the at least one commercial contract including at least two price levels, a first price level if the arbitration provision is selected, and a second price level if the arbitration provision is not selected;
allowing the contracting party to select the first price level with the arbitration provision or the second price level without the arbitration provision;
executing the at least one commercial contract with or without the arbitration provision and at the corresponding price level as selected by the contracting party.

2. The method of claim 1, wherein the second price level is greater than the first price level.

3. The method of claim 1, wherein the difference between the first price level and the second price level is based at least in part on the probability of a dispute related to the commercial contract occurring, the average cost of litigating a dispute related to the commercial contract to a provider of the commercial contract, and the average cost of arbitrating a dispute related to the commercial contract to the provider of the commercial contract.

4. The method of claim 1, wherein providing a contracting party with at least one commercial contract and providing the contracting party with an option with at least one commercial contract of having an arbitration provision or not having an arbitration provision includes providing a contracting party with at least two commercial contracts, a first commercial contract including an arbitration provision and a second commercial contract not including an arbitration provision.

5. The method of claim 1, wherein providing a contracting party with at least one commercial contract and providing the contracting party with an option with the commercial contract of having an arbitration provision or not having an arbitration provision includes providing a contracting party with a single commercial contract including an arbitration provision that may be affirmatively selected by the contracting party.

6. The method of claim 5, wherein the single commercial contract includes language that indicates in effect that by selecting the arbitration provision the contracting party is waiving the contracting party's right to pursue any dispute in court.

7. The method of claim 5, wherein the single commercial contract includes a section for the contracting party to affirmatively indicate an arbitration provision is not being selected.

8. The method of claim 5, wherein the single commercial contract includes at least a first section for the contracting party to affirmatively indicate an arbitration provision is being selected, the first section indicating the first price level, and a second section to affirmatively indicate an arbitration provision is not being selected, the second section indicating the second price level.

9. The method of claim 1, wherein the commercial contract is a senior care contract.

10. A method of providing two-tier senior care pricing, comprising the steps of:
providing a senior care contracting party with a senior care contract, the senior care contract including at least an option for an arbitration provision in the senior care contract and corresponding first price level and an option to not include an arbitration provision in the senior care contract and corresponding second price level different than the first price level;
allowing the senior care contracting party to select the option for an arbitration provision in the senior care contract and corresponding first price level or the option to not include an arbitration provision in the senior care contract and corresponding second price level;
executing the senior care contract with the arbitration provision in the senior care contract and corresponding first price level or without the arbitration provision in the senior care contract and corresponding second price level.

11. The method of claim 10, wherein the second price level is greater than the first price level.

12. The method of claim 10, wherein the difference between the first price level and the second price level is based at least in part on the probability of a dispute related to the commercial contract occurring, the average cost of litigating a dispute related to the commercial contract to a provider of the commercial contract, and the average cost of arbitrating a dispute related to the commercial contract to the provider of the commercial contract.

13. The method of claim 10, wherein the senior care contract includes language that indicates in effect that by selecting the arbitration provision the senior care contracting party is waiving the senior care contracting party's right to pursue any dispute in court.

14. A method of providing two-tier senior care pricing, comprising the steps of:
providing a senior care contracting party with at least two senior care contracts, a first senior care contract including an arbitration provision and a corresponding first price level and a second senior care contract without an arbitration provision and a corresponding second price level different than the first price level;
allowing the senior care contracting party to select at least the first senior care contract with an arbitration provision at the first price level or the second senior care contract without an arbitration provision at the second price level;
executing either the first senior care contract with an arbitration provision at the first price level or the second senior care contract without an arbitration provision at the second price level.

15. The method of claim 14, wherein the second price level is greater than the first price level.

16. The method of claim 14, wherein the difference between the first price level and the second price level is based at least in part on the probability of a dispute related to the commercial contract occurring, the average cost of litigating a dispute related to the commercial contract to a provider of the commercial contract, and the average cost of arbitrating a dispute related to the commercial contract to the provider of the commercial contract.

17. The method of claim 14, wherein the first senior care contract includes language indicating in effect that the senior care contracting party has the option of a senior care contract without an arbitration provision at a second price level.

18. The method of claim 14, wherein the second senior care contract includes language indicating in effect that the senior care contracting party has the option of a senior care contract with an arbitration provision at a first price level.
